(19) United States
(12) Patent Application Publication
(10) Pub. No.: US 2016/0292970 A1
(43) Pub. Date: Oct. 6, 2016

(54) MIX AND MATCH BLACKJACK GAME

(71) Applicant: Robert Barragan, Las Vegas, NV (US)

(72) Inventor: Robert Barragan, Las Vegas, NV (US)

(21) Appl. No.: 14/677,977

(22) Filed: Apr. 3, 2015

(51) Int. Cl. G07F 17/32; A63F 1/00

(52) U.S. Cl. CPC G07F 17/3293; A63F 1/00; G07F 17/323; G07F 17/3244; A63F 2001/003

(57) ABSTRACT

A method for conducting a card game by:
accepting an ante wager on a round of blackjack at a player position;
providing three random playing cards to a player position and three random cards to a dealer position,
the game being according to the predetermined rules of blackjack;
the player position discards one card to form an initial player position two-card blackjack hand;
the dealer position discards one card to form an initial dealer position two-card blackjack hand,
the player position receives random cards to complete a blackjack hand at the player position according to player position direction to stand or hit;
the dealer position receiving random cards to complete a blackjack hand at the dealer position after f) is completed according to dealer position direction to stand or hit; and
the dealer resolving all wagers at the player position hand by standard blackjack rules of resolution.

### BACKGROUND OF THE INVENTION

1. Field of the Invention

The present invention relates to the field of table gaming, player and table gaming, blackjack games and wagers made on play in blackjack.

2. Background of the Art

Blackjack is one of the more long-lived and prevalent casino wagering games.

Card games have always been popular as wagering games. The history of card games reaches back into biblical eras. One of the most popular card games, especially for gambling or gaming uses is the card game known as Blackjack (or “21”) wherein a blackjack player plays against a dealer and the object is to beat the dealer's hand by reaching a total point value closest to 21, without exceeding a point count of twenty-one and/or by having the dealer's point count exceed twenty-one. The player may exercise strategies including adjusting his point count either by maintaining his original cards and card count (e.g., referred to as “standing,” not drawing a card that might cause the Blackjack player to ‘bust, that is go over 21) and hope that the dealer will bust or by accepting additional cards (referred to as ‘hitting’ or ‘taking a hit’), attempting to receive a cumulative point card total higher (not exceeding a total point count of 21) than the total point count that the Dealer will ultimately attain. If both the Blackjack player and the dealer each achieve a point count total that does not exceed 21, then the highest total (as between individual players and the dealer) wins the bet. Blackjack is relatively simple to understand and is usually a faster and easier card game to play than, for example, the game of Poker, therefore Blackjack, which can be played with the dealer and only one Blackjack player, tends to be more popular than the conventional game of Poker which needs to be played with several players because each of the Poker players are competing against each other for one pot whereas each Blackjack player can win against the one dealer. Even with variants of poker being played in casinos (e.g., Let It Ride® poker, Three Card Poker®, Crazy 4 Poker™, Caribbean Stud® poker, etc.), Blackjack remains the most popular card game in casinos, with many more tables usually dedicated to blackjack than to all other card games combined.

Blackjack must include a dealer (in mechanical, electromechanical, electronic or video versions of the game, a virtual dealer's hand is provided) and there must be at least one Blackjack player. One or more Blackjack players playing against the Dealer are, in effect, individually competing to try to either obtain a better total card point count than the point count of the dealer, without exceeding a total point count in the player's hand of 21 (for the total number of multiple playing cards that they the dealer is dealt). The player may stand after receiving a minimum of 2 cards and hope that the Dealer will bust. There are many variants on strategies that are used in the play of cards that are dependent upon a consideration of the player's cards in comparison with the dealer's cards. There are preferred and optimal strategies that may be used, with some strategies possibly influenced by card counting by the player.

For example, Blackjack players seeing a dealer's exposed card as a 2, 3, 4, 5 or 6, will themselves elect to take no hits when the player's point count is 12, 13, 14, 15 or 16 in the hopes that the dealer's hitting (which is required when the dealer's point count is 16 or less) will result in a bust. The objective of the player is that with the exposed card being generally incapable of having a starting point count where the dealer may stand (the exception being a disclosed card of a 6 and a hole card of an ace), the dealer will take hits to a point total that exceeds 21 and therefore break (or “bust”), allowing the player to win the hand. The player will win the bet if the dealer has to hit (the Dealer is required to draw if their point total is 16 or less) and the Dealer busts (goes over 21). Blackjack players also have the option of splitting any pairs (i.e., a pair of cards of identical point count value, such as two face cards, a 10 and a face card, a pair of 10s, a pair of 9s, a pair of 3's, etc.). Blackjack players have several options such as to double down (double their bet and receive only one more card), double their bet when they split a pair of cards, and can receive a 1.5 times their bet return if they receive an Ace and a 10 or picture card for their other card. A Blackjack player receiving a card score of more than 21 points has a bust hand and automatically loses to the dealer. If the dealer accumulates cards with a point count in excess of 21, the dealer busts, and every player remaining in the game (those players who have not busted themselves) wins the hand. The dealer, after receiving the first 2 cards begins drawing one or more cards (if the first 2 cards are 16 or less), but only after each of the Blackjack players at the dealer's table have played their hands to completion. Therefore, the house or casino has the advantage because the Blackjack player or players must play and complete their hand first or before the dealer plays or completes his hand. The Blackjack players at the table individually play against the dealer. The dealer must receive a minimum of 2 cards and attain a point count of at least 17 before the dealer may stop taking cards. Each of the Blackjack players individually playing against the dealer (who is a representative of the house or casino) has the option of standing after the receipt of their 2 initial cards. This means that the player will have the options of not receiving any other cards or to draw one or more other cards from the dealer and to continue drawing cards until the player is either satisfied with their card count score and stops drawing cards (stands) or the player has busted (gone over the 21 point total). As is known in the Blackjack card game, picture cards (Jacks, Queens and Kings) each have a point card value of 10 points while Aces have a point card value of either 1 point or 11 points. The other cards namely 2s, 3s, 4s, 5s, 6s, 7s, 8s, 9s and 10s have a point card value equivalent to their face card value (i.e., respectively 2, 3, 4, 5, 6, 7, 8, 9, and 10). In most gaming or casino establishments, dealers have to draw when they receive a point card value of 16 or less and, in some Casinos or gaming establishments, when they receive a point card value of 17 or less where the 17 point card value is based upon using an Ace as an 11 point card value with one or more other cards (this is known as a soft 17).

While Blackjack or 21 is a relatively fast-playing popular card game, it is always desirable to offer the players opportunities for variations in the game to maintain their long-term interest. Other betting options are desirable for the Blackjack player other than just varying the size of their wagers. Thus a Blackjack game is needed which would permit the Blackjack player to have a chance to win a large bet (as a regular option or an option after losing a number of conventional bets to the dealer) without the risk of losing a large bet that was the only previous option to try to promptly recoup a series of lost bets to the Dealer.

Attempts have been made to vary the game of Blackjack to a relatively minor degree wherein a Blackjack player could have more than one betting option other than the Blackjack player's bet to receive a higher card total not more than the maximum of 21 than the Dealer or to hope that the Dealer busts. However, these other attempts have not been successful because they do not provide a multitude of very exciting betting options combined with a large jackpot type of payout. U.S. Pat. No. 5,454,570 to Karal discloses a Blackjack card game method therein a Blackjack player has extended wagering opportunities after the Blackjack player's hand has reached a desired card count value. Specifically, the Blackjack player can bet on whether the Dealer will achieve a card count that would be higher (but not greater than 21) than the Blackjack player's hand. This supplemental bet or wager by the Blackjack player is prior to the Dealer revealing the Dealer's face down card. Predetermined odds on the different possible Dealer hand combinations are selected by the Blackjack player by the selection of the point card value of the Dealer's hand. Also, the Blackjack player can wager on the point card value of the Dealer's only face down card. Furthermore, the Blackjack player can bet on the point card value of the third Dealer card, etc. The odds presented in this U.S. patent range from 10 to 1 (on an Ace being the Dealer down card or the next card to be drawn by the Dealer). Picture cards including 10s have a 2 to 1 betting ratio.

Blackjack is generally conducted using one or more decks of fifty-two cards each. Each player makes a wager to receive two cards. A dealer also receives two cards, one of which is exposed. Each player forms a final player hand by opting to stand, hit (draw more cards), double down with an additional wager, or split the pair if the two cards are of the same rank. If the player doubles down, he has to put up an additional wager equal to his initial wager and then the dealer will deal him only one card. If the player hits and busts (i.e., the sum of the cards in his hand goes over a target value of 21), then the player loses his wager immediately. If the player splits a pair, he must put up an additional wager equal to his initial wager and split the pair into two hands. Where the house rules allow for double down after split, the player may double down after splitting a pair by putting up a double down wager next to the wager on the hand being doubled. Where the house rules allow for surrender, the player may surrender his hand and forfeit half the wager.

After each player has formed a final player hand or busted, a final dealer hand is formed. If the initial dealer hand is not 17 or greater, additional cards are drawn to the dealer hand until his hand is 17 or greater. If the dealer busts (i.e. has a hand value greater than 21), all players who did not already bust are rewarded. Otherwise, the numerical value of each player hand is compared to the numerical value of the dealer hand. In determining a numerical hand value, aces count one or eleven, face cards count ten, and all other cards count their face value. For each comparison, whoever has a hand closer to 21 wins. If the dealer hand and the player hand are equal, the player's wager is returned.

A blackjack variant known as Spanish 21 is disclosed in U.S. Pat. No. 5,615,888. Spanish 21, dealt with reduced decks with four tens removed from each deck, provides some rule modifications that favor the player. For example, the player is allowed to not only double down on any number of cards but also take back the double down wager if he dislikes the double down card dealt to him.

Another blackjack variant known as Super Fun 21 is disclosed in U.S. Pat. No. 5,979,897. Super Fun 21, dealt with standard decks of 52 cards, provides not only the same double down options as Spanish 21 but also the option of surrendering half the bet on any hand including after splitting.

Another blackjack variant is disclosed in U.S. Pat. No. 6,598,879. An optional side bet known as “hit insurance” is provided such that a player may insure his hand against being broken (busted) if he draws one or more cards.

Another blackjack variant is disclosed in U.S. Pat. No. 6,604,741 entitled “Split card feature during continued play of blackjack.” If a last additional card dealt matches a value of any previously dealt card, the player is allowed to separate the last additional card into a second hand. For example, a single card may be split off by the player after taking a hit when the hit card matches an earlier dealt card, such as one or the other of the two first cards in the original hand or another hit card.

Another blackjack variant is disclosed in U.S. Pat. No. 7,384,045. A “double down split” option is provided so that the player who wishes to double down can put up an additional wager for an additional hand that shares the original two cards dealt to him. For example, a player who receives 9-2 in his original two cards may elect to “split double” and create a second hand by matching his original wager. Now the two hands will share the 9-2 as their starting hand but will receive their own double down card respectively.

U.S. Pat. No. 8,474,821 (Ko) describes a method for conducting blackjack-style wagering games includes favorable player options to enhance its appeal. Various double down options are available for the player to either increase his win or reduce his loss when doubling down with an additional wager. An improved method for conducting a blackjack-style card game using: a processor sending virtual images of playing cards to a display system at each player position, the blackjack-style card game being played between a dealer position and at least one player position at a physical gaming table according to the predetermined rules of blackjack card games utilizing playing cards where all face cards count ten, aces count one or eleven, and all other cards count their face value, in which the processor recognizes each player position making an initial wager and the processor randomly distributes an initial player position hand of two cards to each player position and at least one card to the dealer position, the improved method comprising after the player position exercises a double down option by placing a double down wager and taking a single hit card, the processor resolving the player position hand by one of the following steps: i. If the player position doubles down on a predetermined count of his hand and the player's position count total equals a predetermined value after taking the hit card, the processor effects that the player position loses only one of the initial wager and the double down wager if the dealer position hand beats the player position hand; ii. If the player position doubles down on a total of 10 and draws a 10, the player position hand will be caused by the processor to always push or lose exactly one of the initial wager and the double down wager, if the dealer position hand has 21; and iii. If one or more of the following criteria can be satisfied, reward the player position at a rate against at least one player position wager of more than 1 to 1 if the player position hand beats the dealer position hand: a) the final player position hand has a predetermined total; b) the hit card has a predetermined rank; c) the point spread between the final player position hand the final dealer position hand matches a predetermined value or range; d) the dealer's position up card or hole card has a predetermined rank or falls within a predetermined range; and e) the final dealer position hand has a predetermined total.

### SUMMARY OF THE INVENTION

A method for conducting a blackjack-style card game where:
a) a dealer (live or virtual) accepts an ante wager on a round of blackjack at a player position;
b) the dealer providing exactly three random playing cards to a player position and exactly three random cards to a dealer position, and
c) the game being played between a dealer position and the player position at a physical or electronic gaming table according to the predetermined rules of blackjack, in which the dealer recognizes each player position making the ante wager;
d) the player position discards one of the three player position cards to form an initial player position two-card blackjack hand;
e) the dealer position discards one of the three dealer position cards to form an initial dealer position two-card blackjack hand,
f) the player position receiving random cards to complete a blackjack hand at the player position according to player position direction to stand or hit;
g) the dealer position receiving random cards to complete a blackjack hand at the dealer position after f) is completed according to dealer position direction to stand or hit; and
h) the dealer resolving all wagers at the player position hand by standard blackjack rules of resolution.

### BRIEF DESCRIPTION OF THE FIGURES

FIG. 1 shows an electronic gaming table on which the gaming method may be executed.

FIG. 1A shows a schematic for an electronic system for enabling play of the gaming method described herein.

FIG. 1B shows another schematic for an electronic system for enabling play of the gaming method described herein.

### DETAILED DESCRIPTION OF THE INVENTION

A method for conducting a blackjack card game using:
a) accepting an ante wager on a round of blackjack at a player position;
b) providing three random playing cards to a display system at a player position and three random playing cards to a dealer position,
c) the blackjack card game being played between the dealer position and the player position according to the predetermined rules of blackjack card games utilizing playing cards where all face cards count ten, aces count one or eleven, and all other cards count their face value, in which each player position makes the ante wager; d) the player position discards one card to form an initial player position two-card blackjack hand;
e) the dealer position discards one card to form an initial dealer position two-card blackjack hand;
f) the player position receives random cards to complete a blackjack hand at the player position according to player position direction to stand or hit;
g) the dealer position receiving random cards to complete a blackjack hand at the dealer position after f) is completed according to dealer position direction to stand or hit; and
h) the dealer resolving all wagers at the player position hand by standard blackjack rules of resolution.

An alternative method of play is described as a method for conducting a blackjack card game using physical playing cards in which:
a) a dealer accepts an ante wager on a round of blackjack at a player position;
b) the dealer sending three random physical playing cards to a display area at a player position and three random physical playing cards to a dealer position display area, where at most one of the dealer position three random cards is displayed,
c) the blackjack card game being played between the dealer position and the player position according to the predetermined rules of blackjack card games utilizing playing cards where all face cards count ten, aces count one or eleven, and all other cards count their face value, in which each player position makes the ante wager;
d) the player position discards one card from the player position three playing cards to form an initial player position two-card blackjack hand;
e) the dealer position discards one card from the dealer position three playing cards to form an initial dealer position two-card blackjack hand;

The method may have the three player position cards are physical playing cards dealt from a randomized set of playing cards, and the three dealer position cards are physical playing cards dealt from the randomized set of playing cards.

The random cards may be dealt from a dealer shoe containing a randomized set of playing cards.

The random cards may be dealt individually from an output tray on an electromechanical shuffling machine.

The random cards may be dealt in packets of three cards from an output tray on an electromechanical shuffling machine, in which the method would be a A method for conducting an electronic blackjack-style card game using:
a) a processor accepting an ante wager on a round of blackjack at a player position from a player input terminal;
b) the processor sending virtual images of three virtual random playing cards to a display system at the player position;
c) the processor sending virtual images of three virtual random playing cards to a display system at a dealer position;
d) the player position receiving signals at the player input terminal directing discard of a specific one of the three virtual playing cards at the player position to form an initial two-card player position blackjack hand;
e) the player position completing a final player position blackjack hand by receipt of signals through the player input terminal of commands to the processor to hit or stand at the player position;
f) after completion of a final player position blackjack hand, the dealer position two-card initial virtual playing card hand is completed by exercise of commands by the processor according to procedures stored in memory; and
g) the processor resolving the ante wager according to blackjack comparison between a virtual player hand outcome and a virtual dealer hand outcome. There could be specific physical controls selected from the group selected from an area on a touchscreen and buttons are manipulated to direct a hit or a stand at the dealer position. The specific controls might also include an area on a touchscreen and buttons are manipulated to suggest a strategy to the player position as to whether to hit, stand or double-down on at least a two-card hand. The underlying execution of the method may include events wherein a player makes a first wager and is dealt three cards either face up or face down. The dealer is dealt two cards face down and one card face up. The player acts first. The player will examine his three cards and discard one card. The remaining two card-hand point total will be the player's starting hand in a basically traditional blackjack event. After player chooses which card to discard, the dealer will muck that card. The player will then play his hand under normal 21 rules (choosing to hit, stand, double down, or split).

After all individual players have acted, the dealer will reveal all three cards. The dealer will chose to discard one card and keep the other two in play. The dealer will use the following procedures to determine which card to discard called the Hi/Lo method.

If the dealer can make a 17, 18, 19, 20, or 21 with two of the three cards present, the dealer will make the highest of those hands and discard the remaining card (obviously in a situation where the dealer's three cards were 10, 10, 9, the dealer would discard the 9 to make a two-card hand of 20).

If the dealer cannot make a 17, 18, 19, 20, or 21, the dealer will set the hand with the following priorities:

If the dealer can make a 2-card point total of 11 or 10, the dealer will prioritize that setting.

If the dealer cannot make a 2-card 11 or 10 and has an ace, the dealer will prioritize making the lowest soft point total (such as a soft 12).

If the dealer cannot make a 2-card 11 or 10 and does not have an ace, the dealer will choose the two cards that produce the lowest point total. For example, if the dealer has 10, 6, and 2, the dealer will select the 6 and 2 to make an 8 point total.

After the dealer has selected the card to discard, the dealer will follow standard drawing rules until he has made a 17, 18, 19, 20 or 21 point total or has “busted” with a total greater than 21.

One of the strengths of this game is that if offers players more flexibility in setting their hand. Ultimately, this will lead to fewer busts and more pushes. In standard 21, the fact that the player must act first (and risk busting) before the dealer acts is fundamental in producing the house advantage. In order to compensate for this shift, some changes are desirable to ensure a viable house advantage.

The mathematic analysis for this game is not yet complete, so the following are suggestions for ensuring a house advantage remains.

Player Natural 21: Players can no longer be paid 3:2 for a natural 21. If two of the three player cards combine to make 21 (a three card 21 cannot be played), the player will not be paid a 3:2 bonus pay (however it may still be possible to pay the player even money up front as long as the dealer's does not make an initial two-card 21.)

Dealer Natural 21: If the dealers exposed card has a point value of 10 or 11, the dealer will examine the other two face-down cards. If either of the face cards can be used to produce a 21, the dealer will reveal his 21. All players who do not have 2-card a 21 total in their hand will lose their wagers without the opportunity to draw. Any player with an initial 2-card 21 total will push their wager.

The playing cards are physical playing cards (or may be virtual playing cards as described in greater detail later) and all provided physical playing cards are random physical playing cards provided from a randomized first set of playing cards, or random cards selected from the first set of playing cards. The random physical playing cards may be provided from a randomized set of playing cards in a delivery shoe and cards may be provided from the shoe from a random order of the playing cards in the delivery shoe. For example, the random physical playing cards may be provided from a delivery tray in an electromechanical device that provides randomized physical playing cards into the delivery tray.

In an electronic gaming system, the playing cards are virtual playing cards displayed on a video display screen, wagers are accepted by a processor and wagers are input from a player control input at the player position. The player position may be a stand-alone system or one of multiple player positions at an electronic gaming table with multiple player control inputs. Each player input control may be a touchscreen, buttons on a panel, toggles, or other manual or biometric sensing controls.

The game may be played with physical playing cards or with virtual electronic gaming apparatus, mixed physical and electronic systems or on-line electronic gaming systems.

This method may use physical playing cards wherein the randomization is effected by shuffling of the physical playing cards, as by manual shuffling or an electromechanical shuffler. The physical playing cards are preferably a single deck of physical playing cards and randomization is effected by automated electromechanical shuffling of the physical playing cards. The playing cards may be virtual playing cards and the method is performed on a system comprising a processor, a video display screen and player input controls and the processor displays hands at a virtual player position and a virtual dealer position and a random number generator provides random individual cards for the first subset of playing cards and the second subset of playing cards. The set of playing cards should comprise at least a standard deck of playing cards, fifty-two cards having four suits (spades, hearts, diamonds and clubs) having ranks from 2 to Ace. Multiple decks and/or specialty cards may also be included with the deck. The deck(s) must be randomized by shuffling to provide cards in a random order. The transformation of cards into a random order must be done before the play of each round of the game so that the cards provided cannot be predicted with any significant degree of certainty. The dealer controls the play of the game and dictates the rules of play of the game. The dealer will not allow cards to be dealt to player positions unless the appropriate wager is verified by the dealer. The dealer segments the shuffled set of playing cards into random content subsets of exactly the number of cards that the dealer must provide in each step of the method. The cards may be manually dealt or automatically dealt by a shuffling apparatus. The shuffling apparatus may be a batch shuffler or a continuous shuffler. Cards may be provided one at a time from a delivery position in the shuffler, entire randomized deck(s) may be provided from the shufflers, or individual hands of exactly three cards for delivery to individual player positions and the dealer position. There are a number of variations in the play of the game that may be used.

The shuffling may be performed by a number of various methods, including manual shuffling to produce a randomized set of playing cards. The automatic shufflers may operate by either actually shuffling a portion of or entire set of playing cards (e.g., one or more decks of playing cards), or by providing hands or subsets of playing cards randomly out of the original complete set of playing cards.

The cards may be batch shuffled or continuously shuffled (returned, spent cards from previous hands are returned to the machine and randomly distributed among cards already in the machine). The shuffling mechanism may be accomplished by use of carousels (or linear moving stacked arrays) of multiple compartments into which cards are inserted (randomly or in predetermined locations among the compartments) and then unloaded from the compartments (randomly or in predetermined order of compartments) so that random hands or subsets of playing cards are distributed to a delivery area for distribution by the dealer. The cards may also be delivered to a delivery tray by random removal (e.g., random ejection as understood in the art, or random removal by any other technology) from the original set and delivery of the randomly withdrawn/removed cards to the delivery tray to form random hands or random subsets in the delivery tray.

The game may also be played as a video gaming system, with either a single player terminal or multiple player terminals against a dealer hand. Multiplayer playstations with 4-7 players at seats before a virtual dealer on a screen may also be used.

Computer-Based Implementations

Methods of the present invention may be implemented in computer hardware, software, or computer hardware and software. A most common form of computer implementation is a stand-alone, single player electronic gaming machine with electronic player controls and one or more video output screens.

In computer-based embodiments, the gaming device preferably includes at least one processor, such as a microprocessor, a microcontroller-based platform, a suitable integrated circuit or one or more application-specific integrated circuits (ASIC's) or Field Programmable Gated Arrays (FPGA's). The processor is in communication with or operable to access or to exchange signals with at least one data storage or memory device, and/or a player monitor or monitors. In one embodiment, the processor and the memory device reside within the cabinet of a gaming device. Multiple gaming devices are typically connected to a casino information network.

The memory device stores program code and instructions, executable by the processor, to control the gaming device. The memory device also stores other data such as image data, event data, player input data, random or pseudo-random number generators, pay-table data or information, House Ways distributions and applicable game rules that relate to the play of the gaming device. In one embodiment, the memory device includes random access memory (RAM): which can include non-volatile RAM (NVRAM): magnetic RAM (MRAM), ferroelectric RAM (FeRAM), and other forms as commonly understood in the gaming industry. In one embodiment, the memory device includes read only memory (ROM). In one embodiment, the memory device includes flash memory and/or EEPROM (electrically erasable programmable read only memory). Any other suitable magnetic, optical, and/or semiconductor memory may operate in conjunction with the gaming device disclosed herein.

In one embodiment, part or all of the program code and/or operating data described above can be stored in a detachable or removable memory device, including, but not limited to, a suitable cartridge, disk, CD ROM, DVD, or USB memory device.

In other embodiments, part or all of the program code and/or operating data described above can be downloaded to the memory device through a suitable network. In one embodiment, an operator or a player can use such a removable memory device in a desktop computer, a laptop computer, a personal digital assistant (PDA), a portable computing device, or another computerized platform to implement the present disclosure. In one embodiment, the gaming device or gaming machine disclosed herein is operable over a wireless network, for example part of a wireless gaming system. The gaming machine may be a hand-held device, a mobile device, or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission. It should be appreciated that the processor and memory device may be collectively referred to herein as a “processor” or “computer” or “controller” or “game controller.”

In one embodiment, as discussed in more detail below, the gaming device randomly generates awards and/or other game outcomes based on probability data. In one such embodiment, this random determination is provided through utilization of a random number generator (RNG), such as a true random number generator, a pseudo random number generator, or other suitable randomization process. In one embodiment, each award or other game outcome is associated with a probability and the gaming device generates the award or other game outcome to be provided to the player based on the associated probabilities. In this embodiment, since the gaming device generates outcomes randomly or based upon one or more probability calculations, there is no certainty that the gaming device will ever provide the player with any specific award or other game outcome. It is also possible for templates or weighted templates of sets of tiles or paylines as disclosed in U.S. Pat. Nos. 6,159,096 and 6,117,009 (Yoseloff, which are incorporated by reference in their entirety) which disclose a method of configuring a video output gaming device to randomly generate game outcomes. The method includes the steps of selecting a set of game symbols, assigning a probability of occurrence to each symbol, selecting a plurality of outcome templates, each template comprising X variables, selecting a probability of occurrence for each outcome template, assigning a subset of symbols from the set of game symbols to each template for filling the positions, defining payouts for selected outcomes, and configuring a video output gaming device, which randomly selects a template, randomly selects a symbol for each variable in the template from the subset of game symbols assigned to the selected template, randomly fills at least a portion of the positions in the template and displays the outcome on a video output display. A video output gaming device programmed to randomly select a template, randomly select symbols to define the variables and randomly display the selected symbols is also disclosed. In one embodiment, described in more detail below as a “chipless gaming platform”, the gaming device includes one or more display devices that are mounted into a gaming table surface and are controlled by the processor in addition to or separately from the individual player monitors. The display devices are preferably connected to or mounted into the table structure. This may include a central display device which displays a primary game, dealer images, jackpot information, or information that is not specifically related to the game, such as sports information or winning events at other tables. This display device may also display any suitable secondary game associated with the primary game as well as information relating to the primary or secondary game (e.g., side bets, bonuses, jackpots and the like).

An alternative embodiment may include a central horizontal game display device and a vertically oriented virtual dealer display device as in Shuffle Master, Inc.'s Table Master™ gaming system. The central display device may display the primary game, any suitable secondary game associated or not associated with the primary game and/or information relating to the primary or secondary game. These display devices may also serve as digital glass operable to advertise games or other aspects of the gaming establishment. The gaming device includes a credit display 20 which displays a player's current number of credits, cash, account balance, or the equivalent. In one embodiment, the gaming device includes a bet display displays a player's amount wagered. In one embodiment, as described in more detail below, the gaming device includes a player tracking display which displays information regarding a player's play tracking status.

In yet another embodiment, at least one display device may be a mobile display device, such as a PDA or tablet PC that enables play of at least a portion of the primary or secondary game at a location remote from the gaming device. The display devices may include, without limitation, a monitor, a television display, a plasma display, a liquid crystal display (LCD) a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism.

In one embodiment, as described in more detail below, the display device includes a touch-screen with an associated touch-screen controller. The display devices may be of any suitable size and configuration, such as a square, a rectangle or an elongated rectangle. The display devices of the gaming device are configured to display at least one and preferably a plurality of game or other suitable images, symbols and indicia such as any visual representation or exhibition of the movement of objects such as mechanical, virtual, or video reels and wheels, dynamic lighting, video images, images of people, characters, places, things, faces of cards, images of dealers and the like.

Other forms of the invention are in the form of game software that is implemented in a variety of formats, such as internet gaming, PC practice play, hand-held game devices, wireless gaming devices and the like.

Chipless Gaming Table Implementation One enabling system useful in the practice of the present invention is the use of playing cards with Chinese domino symbols which can be distributed for use with a system marketed under the name i-TABLE™ by Shuffle Master, Inc. of Las Vegas, Nev. That system includes: a) a physical gaming table; b) player monitors at each player position; c) a playing card reading and delivery system (e.g., commercially available shufflers and playing card delivery shoes with reading capability as sold under the Trade names of One2Six™ shuffler, Ace™ shuffler, I-DEAL™ shuffler, I-SHOE™ delivery shoe, etc.); d) a processor receiving information (numbers of cards, rank of cards, suits of cards, etc.) from the card reading and delivery systems; e) communication connectivity (hardwired or wireless) between necessary combinations of the card reading/delivery systems and the processor, the processor and the individual player monitors, and/or the card reading/delivery systems and the video monitors; and f) software in the processor that defines predetermined advantage for distributions of playing cards into multiple hands, game rules, hand history, and the like.

With regard to software f), it is understood in the practice of the present technology that this is not complex software that reads individual player hand cards and determines advantageous card distributions for a first time by extensive calculations.

A preferable card handling device for administering a video or even reel-type-style game is a hand-forming shuffler with integrated card recognition technology, from which playing cards are supplied, with a least a rank/count (and preferable also suit) of individual packs of cards are known before the cards are removed and delivered to player positions and/or the dealer position. The card delivery system 102 is in communication with the controller 128 by wired or wireless communication methods. Communication between the various system components is not limited to electronic or electrical signals, but may include optical signals, audio signals, magnetic transmission or the like.

The individual player position processors (not shown) are preferable graphics processors and not full content CPUs as a cost saving, space saving, and efficiency benefit. With the reduced capacity in the processor as compared to a CPU, there is actually reduced likelihood of tampering and fraudulent input.

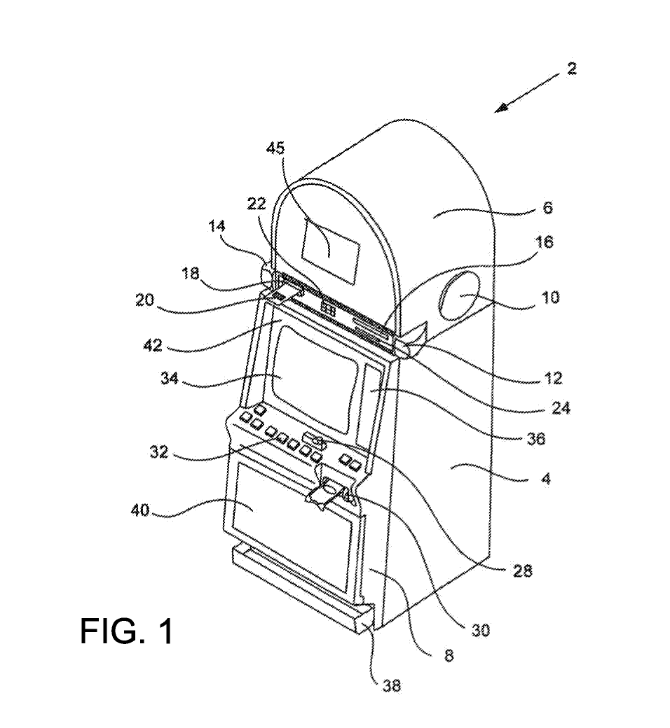

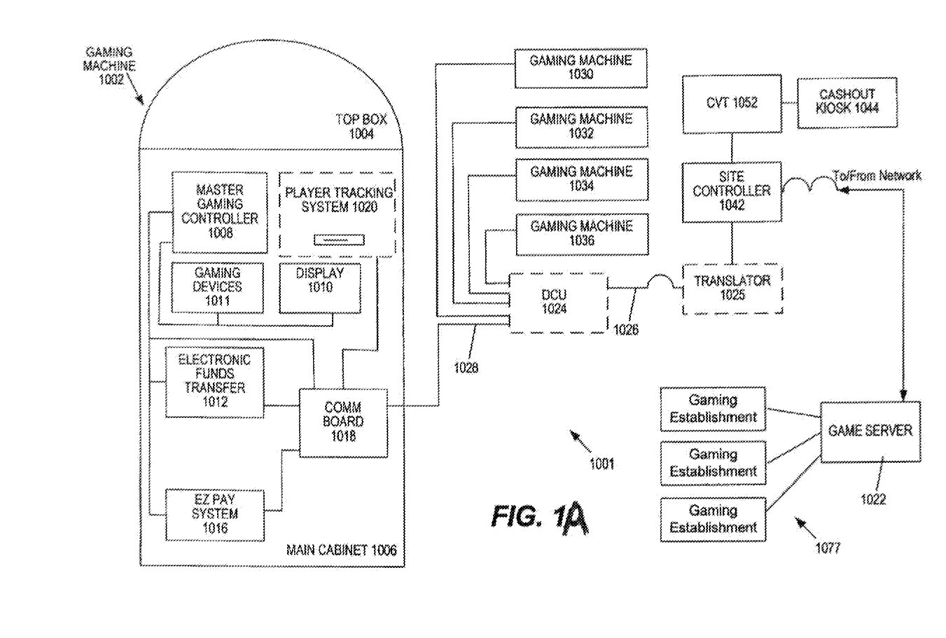

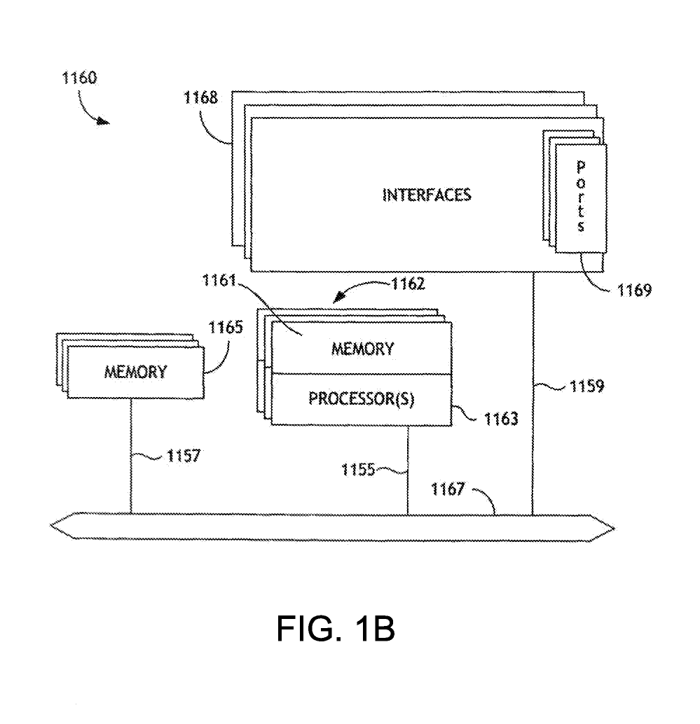

Turning next to FIG. 1, a video gaming machine 2 of the present invention is shown. Machine 2 includes a main cabinet 4, which generally surrounds the machine interior (not shown) and is viewable by users. The main cabinet includes a main door 8 on the front of the machine, which opens to provide access to the interior of the machine. Attached to the main door are player-input switches or buttons 32, a coin acceptor 28, and a bill validator 30, a coin tray 38, and a display area including a mechanical gaming system (or less preferably a separate electronic game) 40. There may be an overlay of touchscreen functionality on the separate electronic game 40 or some of the buttons 32 may be functional on the separate mechanical gaming system 40. That separate mechanical gaming system may be in a relatively vertical viewing position as shown or in a more horizontal (table like) display unit. Viewable through the main door is a video display monitor 34 and an information panel 36. The display monitor 34 will typically be a cathode ray tube, high resolution flat-panel LCD, LED, plasma screen or other conventional electronically controlled video monitor. The information panel 36 may be a back-lit, silk screened glass panel with lettering to indicate general game information including, for example, a game denomination (e.g. $0.25 or $1). The bill validator 30, player-input switches 32, video display monitor 34, and information panel are devices used to play a game on the game machine 2. The devices are controlled by circuitry (e.g. the master gaming controller) housed inside the main cabinet 4 of the machine 2.

Many different types of games, including mechanical slot games, video slot games, video poker, video black jack, video pachinko and lottery, may be provided with gaming machines of this invention. In particular, the gaming machine 2 may be operable to provide a play of many different instances of games of chance. The instances may be differentiated according to themes, sounds, graphics, type of game (e.g., slot game vs. card game), denomination, number of paylines, maximum jackpot, progressive or non-progressive, bonus games, etc. The gaming machine 2 may be operable to allow a player to select, a game of chance to play from a plurality of instances available on the gaming machine. For example, the gaming machine may provide a menu with a list of the instances of games that are available for play on the gaming machine and a player may be able to select from the list a first instance of a game of chance that they wish to play.

The various instances of games available for play on the gaming machine 2 may be stored as game software on a mass storage device in the gaming machine or may be generated on a remote gaming device but then displayed on the gaming machine. The gaming machine 2 may executed game software, such as but not limited to video streaming software that allows the game to be displayed on the gaming machine. When an instance is stored on the gaming machine 2, it may be loaded from the mass storage device into a RAM for execution. In some cases, after a selection of an instance, the game software that allows the selected instance to be generated may be downloaded from a remote gaming device, such as another gaming machine.

The gaming machine 2 includes a top box 6, which sits on top of the main cabinet 4. The top box 6 houses a number of devices, which may be used to add features to a game being played on the gaming machine 2, including speakers 10, 12, 14, a ticket printer 18 which prints bar-coded tickets 20, a key pad 22 for entering player tracking information, a florescent display 16 for displaying player tracking information, a card reader 24 for entering a magnetic striped card containing player tracking information, and a video display screen 42. The ticket printer 18 may be used to print tickets for a cashless ticketing system. Further, the top box 6 may house different or additional devices than shown in the FIG. 1. For example, the top box may contain a bonus wheel or a back-lit silk screened panel which may be used to add bonus features to the game being played on the gaming machine. As another example, the top box may contain a display for a progressive jackpot offered on the gaming machine. During a game, these devices are controlled and powered, in part, by circuitry (e.g. a master gaming controller) housed within the main cabinet 4 of the machine 2.

Understand that gaming machine 2 is but one example from a wide range of gaming machine designs on which the present invention may be implemented. For example, not all suitable gaming machines have top boxes or player tracking features. Further, some gaming machines have only a single game display mechanical or video, while others are designed for bar tables and have displays that face upwards. As another example, a game may be generated in on a host computer and may be displayed on a remote terminal or a remote gaming device. The remote gaming device may be connected to the host computer via a network of some type such as a local area network, a wide area network, an intranet or the Internet. The remote gaming device may be a portable gaming device such as but not limited to a cell phone, a personal digital assistant, and a wireless game player. Images rendered from 3-D gaming environments may be displayed on portable gaming devices that are used to play a game of chance. Further a gaming machine or server may include gaming logic for commanding a remote gaming device to render an image from a virtual camera in a 3-D gaming environments stored on the remote gaming device and to display the rendered image on a display located on the remote gaming device. Thus, those of skill in the art will understand that the present invention, as described below, can be deployed on most any gaming machine now available or hereafter developed.

Some preferred gaming machines are implemented with special features and/or additional circuitry that differentiates them from general-purpose computers e.g., desktop PC's and laptops). Gaming machines are highly regulated to ensure fairness and, in many cases, gaming machines are operable to dispense monetary awards of multiple millions of dollars. Therefore, to satisfy security and regulatory requirements in a gaming environment, hardware and software architectures may be implemented in gaming machines that differ significantly from those of general-purpose computers. A description of gaming machines relative to general-purpose computing machines and some examples of the additional (or different) components and features found in gaming machines are described below.

At first glance, one might think that adapting PC technologies to the gaming industry would be a simple proposition because both PCs and gaming machines employ microprocessors that control a variety of devices. However, because of such reasons as 1) the regulatory requirements that are placed upon gaming machines, 2) the harsh environment in which gaming machines operate, 3) security requirements and 4) fault tolerance requirements, adapting PC technologies to a gaming machine can be quite difficult. Further, techniques and methods for solving a problem in the PC industry, such as device compatibility and connectivity issues, might not be adequate in the gaming environment. For instance, a fault or a weakness tolerated in a PC, such as security holes in software or frequent crashes, may not be tolerated in a gaming machine because in a gaming machine these faults can lead to a direct loss of funds from the gaming machine, such as stolen cash or loss of revenue when the gaming machine is not operating properly.

For the purposes of illustration, a few differences between PC systems and gaming systems will be described. A first difference between gaming machines and common PC based computers systems is that gaming machines are designed. to be state-based systems. In a state-based. system, the system stores and maintains its current state in a non-volatile memory, such that, in the event of a power failure or other malfunction the gaming machine will return to its current state when the power is restored. For instance, if a player was shown an award for a game of chance and, before the award could be provided to the player the power failed, the gaming machine, upon the restoration of power, would return to the state where the award. is indicated. As anyone who has used. a PC, knows, PCs are not state machines and a majority of data is usually lost when a malfunction occurs. This requirement affects the software and hardware design on a gaming machine.

A second important difference between gaming machines and common PC based computer systems is that for regulation purposes, the software on the gaming machine used to generate the game of chance and operate the gaming machine has been designed to be static and monolithic to prevent cheating by the operator of gaming machine. For instance, one solution that has been employed in the gaming industry to prevent cheating and satisfy regulatory requirements has been to manufacture a gaming machine that can use a proprietary processor running instructions to generate the game of chance from an EPROM or other form of non-volatile memory. The coding instructions on the EPROM are static (non-changeable) and must be approved by a gaming regulators in a particular jurisdiction and installed in the presence of a person representing the gaming jurisdiction. Any changes to any part of the software required to generate the game of chance, such as adding a new device driver used by the master gaming controller to operate a device during generation of the game of chance can require a new EPROM to be burnt, approved by the gaming jurisdiction and reinstalled on the gaming machine in the presence of a gaming regulator. Regardless of whether the EPROM solution is used, to gain approval in most gaming jurisdictions, a gaming machine, must demonstrate sufficient safeguards that prevent an operator or player of a gaming machine from manipulating hardware and software in a manner that gives them an unfair and some cases an illegal advantage. The gaming machine should have a means to determine if the code it will execute is valid. If the code is not valid, the gaming machine must have a means to prevent the code from being executed. The code validation requirements in the gaming industry affect both hardware and software designs on gaming machines.

A third important difference between gaming machines and common PC based computer systems is the number and kinds of peripheral devices used on a gaming machine are not as great as on PC based computer systems. Traditionally, in the gaming industry, gaming machines have been relatively simple in the sense that the number of peripheral devices and the number of functions the gaming machine has been limited. Further, in operation, the functionality of gaming machines were relatively constant once the gaming machine was deployed, i.e., new peripherals devices and new gaming software were infrequently added to the gaming machine. This differs from a PC where users will go out and buy different combinations of devices and software from different manufacturers and connect them to a PC to suit their needs depending on a desired application. Therefore, the types of devices connected to a PC may vary greatly from user to user depending in their individual requirements and may vary significantly over time.

Although the variety of devices available for a PC may be greater than on a gaming machine, gaming machines still have unique device requirements that differ from a PC, such as device security requirements not usually addressed by PCs. For instance, monetary devices, such as coin dispensers, bill validators and ticket printers and computing devices that are used to govern the input and output of cash to a gaming machine have security requirements that are not typically addressed in PCs. Therefore, many PC techniques and methods developed to facilitate device connectivity and device compatibility do not address the emphasis placed on security in the gaming industry.

To address some of the issues described above, a number of hardware/software components and architectures are utilized in gaming machines that are not typically found in general purpose computing devices, such as PCs. These hardware/software components and architectures, as described below in more detail, include but are not limited to watchdog timers, voltage monitoring systems, state-based software architecture and supporting hardware, specialized communication interfaces, security monitoring and trusted memory.

A watchdog timer is normally used in gaming machines to provide a software failure detection mechanism. In a normally operating system, the operating software periodically accesses control registers in the watchdog timer subsystem to “re-trigger” the watchdog. Should the operating software fail to access the control registers within a preset timeframe, the watchdog timer will timeout and generate a system reset. Typical watchdog timer circuits contain a loadable timeout counter register to allow the operating software to set the timeout interval within a certain range of time. A differentiating feature of the some preferred circuits is that the operating software cannot completely disable the function of the watchdog timer. In other words, the watchdog timer always functions from the time power is applied to the board.

Gaming computer platforms preferably use several power supply voltages to operate portions of the computer circuitry. These can be generated in a central power supply or locally on the computer board. If any of these voltages falls out of the tolerance limits of the circuitry they power, unpredictable operation of the computer may result. Though most modem general-purpose computers include voltage monitoring circuitry, these types of circuits only report voltage status to the operating software. Out of tolerance voltages can cause software malfunction, creating a potential uncontrolled condition in the gaming computer. Gaming machines typically have power supplies with tighter voltage margins than that required by the operating circuitry. In addition, the voltage monitoring circuitry implemented in gaming computers typically has two thresholds of control. The first threshold generates a software event that can be detected by the operating software and an error condition generated. This threshold is triggered when a power supply voltage falls out of the tolerance range of the power supply, but is still within the operating range of the circuitry. The second threshold is set when a power supply voltage falls out of the operating tolerance of the circuitry. In this case, the circuitry generates a reset, halting operation of the computer.

The standard method of operation for slot machine game software is to use a state machine. Different functions of the game (bet, play, result, points in the graphical presentation, etc.) may be defined as a state. When a game moves from one state to another, critical data regarding the game software is stored in a custom non-volatile memory subsystem. This is critical to ensure the player's wager and credits are preserved and to minimize potential disputes in the event of a malfunction on the gaming machine.

In general, the gaming machine does not advance from a first state to a second state until critical information that allows the first state to be reconstructed is stored. This feature allows the game to recover operation to the current state of play in the event of a malfunction, loss of power, etc. that occurred just prior to the malfunction. After the state of the gaming machine is restored during the play of a game of chance, game play may resume and the game may be completed in a manner that is no different, than if the malfunction had not occurred. Typically, battery backed RAM devices are used to preserve this critical data although other types of non-volatile memory devices may be employed. These memory devices are not used in typical general-purpose computers.

As described in the preceding paragraph, when a malfunction occurs during a game of chance, the gaming machine may be restored to a state in the game of chance just prior to when the malfunction occurred. The restored state may include metering information and graphical information that was displayed on the gaming machine in the state prior to the malfunction. For example, when the malfunction occurs during the play of a card game after the cards have been dealt, the gaming machine may be restored with the cards that were previously displayed as part of the card game. As another example, a bonus game may be triggered during the play of a game of chance where a player is required to make a number of selections on a video display screen. When a malfunction has occurred after the player has made one or more selections, the gaming machine may be restored to a state that shows the graphical presentation at the just prior to the malfunction including an indication of selections that have already been made by the player. In general, the gaming machine may be restored to any state in a plurality of states that occur in the game of chance that occurs while the game of chance is played or to states that occur between the play of a game of chance.

Game history information regarding previous games played such as an amount wagered, the outcome of the game and so forth may also be stored in a non-volatile memory device. The information stored in the non-volatile memory may be detailed enough to reconstruct a portion of the graphical presentation that was previously presented on the gaming machine and the state of the gaming machine (e.g., credits) at the time the game of chance was played. The game history information may be utilized in the event of a dispute. For example, a player may decide that in a previous game of chance that they did not receive credit for an award that they believed they won. The game history information may be used to reconstruct the state of the gaming machine prior, during and/or after the disputed game to demonstrate whether the player was correct or not in their assertion.

Another feature of gaming machines, such as gaming computers, is that they often contain unique interfaces, including serial interfaces, to connect to specific subsystems internal and external to the slot machine. The serial devices may have electrical interface requirements that differ from the “standard” EIA 232 serial interfaces provided by general-purpose computers. These interfaces may include DA 485, ETA 422, Fiber Optic Serial, optically coupled serial interfaces, current loop style serial interfaces, etc. In addition, to conserve serial interfaces internally in the slot machine, serial devices may be connected in a shared, daisy-chain fashion where multiple peripheral devices are connected to a single serial channel.

The serial interfaces may be used to transmit information using communication protocols that are unique to the gaming industry. For example, the Netplex™ system of IGT is a proprietary communication protocol used for serial communication between gaming devices. As another example, SAS is a communication protocol used to transmit information, such as metering information, from a gaming machine to a remote device, Often SAS is used in conjunction with a player tracking system.

Gaming machines may alternatively be treated as peripheral devices to a casino communication controller and connected in a shared daisy chain fashion to a single serial interface. In both cases, the peripheral devices are preferably assigned device addresses. If so, the serial controller circuitry must implement a method to generate or detect unique device, addresses. General-purpose computer serial ports are not able to do this.

Security monitoring circuits detect intrusion into a gaming machine by monitoring security switches attached to access doors in the slot machine cabinet, Preferably, access violations result in suspension of game play and can trigger additional security operations to preserve the current state of game play. These circuits also function when power is off by use of a battery backup. In power-off operation, these circuits continue to monitor the access doors of the slot machine. When power is restored, the gaming machine can determine whether any security violations occurred while power was off, e.g., via software for reading status registers. This can trigger event log entries and further data authentication operations by the slot machine software.

Trusted memory devices are preferably included in a gaming machine computer to ensure the authenticity of the software that may be stored on less secure memory subsystems, such as mass storage devices. Trusted memory devices and controlling circuitry are typically designed to not allow modification of the code and data stored in the memory device while the memory device is installed in the slot machine. The code and data stored in these devices may include authentication algorithms, random number generators, authentication keys, operating system kernels, etc. The purpose of these trusted memory devices is to provide gaming regulatory authorities a root trusted authority within the computing environment of the slot machine that can be tracked and verified as original. This may be accomplished via removal of the trusted memory device from the slot machine computer and verification of the secure memory device contents is a separate third party verification device. Once the trusted memory device is verified as authentic, and based on the approval of the verification algorithms contained in the trusted device, the gaming machine is allowed to verify the authenticity of additional code and data that may be located in the gaming computer assembly, such as code and data stored on hard disk drives. A few details related to trusted memory devices that may be used in the present invention are described in U.S. Pat. No. 6,685,567 titled “Process Verification,” which is incorporated herein in its entirety and for all purposes.

Mass storage devices used in a general purpose computer typically allow code and data to be read from and written to the mass storage device. In a gaming machine environment, modification of the gaming code stored on a mass storage device is strictly controlled and would only be allowed under specific maintenance type events with electronic and physical enablers required. Though this level of security could be provided by software, gaming computers that include mass storage devices preferably include hardware level mass storage data protection circuitry that operates at the circuit level to monitor attempts to modify data on the mass storage device and will generate both software and hardware error triggers should a data modification be attempted without the proper electronic and physical enablers being present.

Returning to the example of FIG. 1, when a user wishes to play the gaming machine 2, he or she inserts cash through the coin acceptor 28 or bill validator 30. Additionally, the bill validator may accept a printed ticket voucher which may be accepted by the bill validator 30 as an indicia of credit when a cashless ticketing system is used. At the start of the game, the player may enter playing tracking information using the card reader 24, the keypad 22, and the florescent display 16. Further, other game preferences of the player playing the game may be read from a card inserted into the card reader. During the game, the player views game information using the video display 34. Other game and prize information may also be displayed in the video display screen 42 located in the top box.

During the course of a game, a player may be required to make a number of decisions, which affect the outcome of the game. For example, a player may vary his or her wager on a particular game, select a prize for a particular game selected from a prize server, or make game decisions which affect the outcome of a particular game. The player may make these choices using the player-input switches 32, the video display screen 34 or using some other device which enables a player to input information into the gaming machine. In some embodiments, the player may be able to access various game services such as concierge services and entertainment content services using the video display screen 34 and one more input devices.

During certain game events, the gaming machine 2 may display visual and auditory effects that can be perceived by the player. These effects add to the excitement of a game, which makes a player more likely to continue playing. Auditory effects include various sounds that are projected by the speakers 10, 12, 14. Visual effects include flashing lights, strobing lights or other patterns displayed from lights on the gaming machine 2 or from lights within the separate mechanical (or electronic) separately, individually wagerable gaming system 40, After the player has completed a game, the player may receive game tokens from the coin tray 38 or the ticket 20 from the printer 18, which may be used for further games or to redeem a prize. Further, the player may receive a ticket 20 for food, merchandise, or games from the printer 18.

Another gaming network that may be used to implement some aspects of the invention is depicted in FIG. 1A. Gaming establishment 1001 could be any sort of gaming establishment, such as a casino, a card room, an airport, a store, etc. In this example, gaming network 1077 includes more than one gaming establishment, all of which are networked to game server 1022.

Here, gaming machine 1002, and the other gaming machines 1030, 1032, 1034, and 1036, include a main cabinet 1006 and a top box 1004. The main cabinet 1006 houses the main gaming elements and can also house peripheral systems, such as those that utilize dedicated gaming networks. The top box 1004 may also be used to house these peripheral systems.

The master gaming controller 1008 controls the game play on the gaming machine 1002 according to instructions and/or game data from game server 1022 or stored within gaming machine 1002 and receives or sends data to various input/output devices 1011 on the gaming machine 1002. In one embodiment, master gaming controller 1008 includes processor(s) and other apparatus of the gaming machines described above. The master gaming controller 1008 may also communicate with a display 1010.

A particular gaming entity may desire to provide network gaming services that provide some operational advantage. Thus, dedicated networks may connect gaming machines to host servers that track the performance of gaming machines under the control of the entity, such as for accounting management, electronic fund transfers (EFTs), cashless ticketing, such as EZPay™, marketing management, and data tracking, such as player tracking. Therefore, master gaming controller 1008 may also communicate with EFT system 1012, EZPay™ system, and player tracking system 1020. The systems of the gaming machine 1002 communicate the data onto the network 1022 via a communication board 1018.

It will be appreciated by those of skill in the art that embodiments of the present invention could be implemented on a network with more or fewer elements than are depicted in FIG. 1A. For example, player tracking system 1020 is not a necessary feature of some implementations of the present invention. However, player tracking programs may help to sustain a game player's interest in additional game play during a visit to a gaming establishment and may entice a player to visit a gaming establishment to partake in various gaming activities. Player tracking programs provide rewards to players that typically correspond to the player's level of patronage (e.g., to the player's playing frequency and/or total amount of game plays at a given casino). Player tracking rewards may be free meals, free lodging and/or free entertainment. Player tracking information may be combined with other information that is now readily obtainable by an SBG system.

Moreover, DCU 1024 and translator 1025 are not required for all gaming establishments 1001. However, due to the sensitive nature of much of the information on a gaming network (e.g., electronic fund transfers and player tracking data) the manufacturer of a host system usually employs a particular networking language having proprietary protocols. For instance, 10-20 different companies produce player tracking host systems where each host system may use different protocols. These proprietary protocols are usually considered highly confidential and not released publicly.

Further, gaming machines are made by many different manufacturers. The communication protocols on the gaming machine are typically hard-wired into the gaming machine and each gaming machine manufacturer may utilize a different proprietary communication protocol. A gaming machine manufacturer may also produce host systems, in which case their gaming machines are compatible with their own host systems. However, in a heterogeneous gaming environment, gaming machines from different manufacturers, each with its own communication protocol, may be connected to host systems from other manufacturers, each with another communication protocol. Therefore, communication compatibility issues regarding the protocols used by the gaming machines in the system and protocols used by the host systems must be considered.

A network device that links a gaming establishment with another gaming establishment and/or a central system will sometimes be referred to herein as a “site controller.” Here, site controller 1042 provides this function for gaming establishment 1001. Site controller 1042 is connected to a central system and/or other gaming establishments via one or more networks, which may be public or private networks. Among other things, site controller 1042 communicates with game server 1022 to obtain game data, such as ball drop data, bingo card data, etc.

In the present illustration, gaming machines 1002, 1030, 1032, 1034 and 1036 are connected to a dedicated gaming network 1022. In general, the DCU 1024 functions as an intermediary between the different gaming machines on the network 1022 and the site controller 1042. In general, the DCU 1024 receives data transmitted from the gaming machines and sends the data to the site controller 1042 over a transmission path 1026. In some instances, when the hardware interface used by the gaming machine is not compatible with site controller 1042, a translator 1025 may be used to convert serial data from the DCU 1024 to a format accepted by site controller 1042. The translator may provide this conversion service to a plurality of DCUs.

Further, in some dedicated gaming networks, the DCU 1024 can receive data transmitted from site controller 1042 for communication to the gaming machines on the gaming network. The received data may be, for example, communicated synchronously to the gaming machines on the gaming network.

Here, CVT 1052 provides cashless and cashout gaming services to the gaming machines in gaming establishment 1001. Broadly speaking, CVT 1052 authorizes and validates cashless gaming machine instruments (also referred to herein as “tickets” or “vouchers”), including but not limited to tickets for causing a gaming machine to display a game result and cash-out tickets. Moreover, CVT 1052 authorizes the exchange of a cashout ticket for cash. These processes will be described in detail below. In one example, when a player attempts to redeem a cash-out ticket for cash at cashout kiosk 1044, cash out kiosk 1044 reads validation data from the cashout ticket and transmits the validation data to CVT 1052 for validation. The tickets may be printed by gaming machines, by cashout kiosk 1044, by a stand-alone printer, by CVT 1052, etc. Some gaming establishments will not have a cashout kiosk 1044. Instead, a cashout ticket could be redeemed for cash by a cashier (e.g. of a convenience store), by a gaming machine or by a specially configured CVT.

FIG. 1B illustrates an example of a network device that may be configured for implementing some methods of the present invention. Network device 1160 includes a master central processing unit (CPU) 1162, interfaces 1168, and a bus 1167 (e.g., a PCI bus). Generally, interfaces 1168 include ports 1169 appropriate for communication with the appropriate media. In some embodiments, one or more of interfaces 1168 includes at least one independent processor and, in some instances, volatile RAM. The independent processors may be, for example, ASICs or any other appropriate processors. According to some such embodiments, these independent processors perform at least some of the functions of the logic described herein. In some embodiments, one or more of interfaces 1168 control such communications-intensive tasks as encryption, decryption, compression, decompression, packetization, media control and management. By providing separate processors for the communications-intensive tasks, interfaces 1168 allow the master microprocessor 1162 efficiently to perform other functions such as routing computations, network diagnostics, security functions, etc.

The interfaces 1168 are typically provided as interface cards (sometimes referred to as “linecards”). Generally, interfaces 1168 control the sending and receiving of data packets over the network and sometimes support other peripherals used with the network device 1160. Among the interfaces that may be provided are FC interfaces, Ethernet interfaces, frame relay interfaces, cable interfaces, DSL interfaces, token ring interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like.

When acting under the control of appropriate software or firmware, in some implementations of the invention CPU 1162 may be responsible for implementing specific functions associated with the functions of a desired network device. According to some embodiments, CPU 1162 accomplishes all these functions under the control of software including an operating system and any appropriate applications software.

CPU 1162 may include one or more processors 1163 such as a processor from the Motorola family of microprocessors or the MIPS family of microprocessors. In an alternative embodiment, processor 1163 is specially designed hardware for controlling the operations of network device 1160. In a specific embodiment, a memory 1161 (such as non-volatile RAM and/or ROM) also forms part of CPU 1162. However, there are many different ways in which memory could be coupled to the system. Memory block 1161 may be used for a variety of purposes such as, for example, caching and/or storing data, programming instructions, etc.

Regardless of network device's configuration, it may employ one or more memories or memory modules (such as, for example, memory block 1165) configured to store data, program instructions for the general-purpose network operations and/or other information relating to the functionality of the techniques described herein. The program instructions may control the operation of an operating system and/or one or more applications, for example.

Because such information and program instructions may be employed to implement the systems/methods described herein, the present invention relates to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media; and hardware devices that are specially configured to store and perform program instructions, such as read-only memory devices (ROM) and random access memory (RAM). The invention may also be embodied in a carrier wave traveling over an appropriate medium such as airwaves, optical lines, electric lines, etc. Examples of program instructions include both machine code, such as produced by a compiler, and files containing higher-level code that may be executed by the computer using an interpreter.

Although the system shown in FIG. 1B illustrates one specific network device of the present invention, it is by no means the only network device architecture on which the present invention can be implemented. For example, an architecture having a single processor that handles communications as well as routing computations, etc. is often used. Further, other types of interfaces and media could also be used with the network device. The communication path between interfaces may be bus based (as shown in FIG. 1B) or switch fabric based (such as a cross-bar).

While this invention is described in terms of preferred embodiments, there are alterations, permutations, and equivalents that fall within the scope of the invention. It should also be noted that there are many alternative ways of implementing the present invention. It is therefore intended that the invention not be limited to the preferred embodiments described herein, but instead that the invention should be interpreted as including all such alterations, permutations, and equivalents as fall within the true spirit and scope of the present invention.

What is claimed:

1. A method for conducting a blackjack card game using physical playing cards in which:
a) a dealer accepts an ante wager on a round of blackjack at a player position;
b) the dealer sending three random physical playing cards to a display area at a player position and three random physical playing cards to a dealer position display area, where at most one of the dealer position three random cards is displayed,
c) the blackjack card game being played between the dealer position and the player position according to the predetermined rules of blackjack card games utilizing playing cards where all face cards count ten, aces count one or eleven, and all other cards count their face value, in which each player position makes the ante wager;
d) the player position discards one card from the player position three playing cards to form an initial player position two-card blackjack hand;
e) the dealer position discards one card from the dealer position three playing cards to form an initial dealer position two-card blackjack hand;
f) the player position receives random physical playing cards to complete a blackjack hand at the player position according to player position directions to stand or hit;
g) the dealer position receiving random physical playing cards to complete a blackjack hand at the dealer position after f) is completed according to dealer position directions to stand or hit; and
h) the dealer resolving all wagers at the player position hand by standard blackjack rules of resolution.

2) The method of claim 1 wherein the three player position cards are physical playing cards dealt from a randomized set of playing cards, and the three dealer position cards are physical playing cards dealt from the randomized set of playing cards.

3. The method of claim 2 wherein the random cards are dealt from a dealer shoe containing a randomized set of playing cards.

4. The method of claim 2 wherein the random cards are dealt individually from an output tray on an electromechanical shuffling machine.

5. The method of claim 2 wherein the random cards are dealt in packets of three cards from an output tray on an electromechanical shuffling machine.

6. A method for conducting a physical game of a blackjack-style card game using:
a) a player wager position on a gaming table receiving an ante wager on a round of blackjack at a player position;
b) the player position receiving exactly three virtual random playing cards at a playing card receiving position at the player position;
c) a dealer position receiving three virtual random playing cards to a dealer hand position at the dealer position at the gaming table;
d) the player position directing discard of a specific one of the three random physical playing cards at the player position and that specific one of the three random physical playing cards being discarded to form an initial two-card player position blackjack hand;
e) the player position completing a final player position blackjack hand taking additional cards until busting or standing;
f)) the dealer position directing discard of a specific one of the three random physical playing cards at the dealer position and that specific one of the three random physical playing cards being discarded to form an initial two-card dealer position blackjack hand
g) after completion of an initial dealer position two-card blackjack hand, the dealer position three-card initial virtual playing card hand is completed; and
g) the dealer position resolving the ante wager according to blackjack comparison between a final player position blackjack hand outcome and a final dealer position blackjack hand outcome.

7. The method of claim 1 wherein the player position discards one card from the player position three playing cards to form an initial player position two-card blackjack hand to form the highest two-card point total of 17, 18, 19, 20 or 21.

8. The method of claim 6 wherein the player position discards one card from the player position three playing cards to form an initial player position two-card blackjack hand to form the highest two-card point total of 17, 18, 19, 20 or 21.

9. The method of claim 1 wherein the dealer position discards one card from the player position three playing cards to form an initial player position two-card blackjack hand to form a hand with a point count of less than 17 in required order of priority of 11, 10, 9, 8, 7, 6, 5, 4, 3, 2, 12, 13, 14, 15 and 16.

10. The method of claim 1 wherein the dealer position discards one card from the player position three playing cards to form an initial player position two-card blackjack hand to form a hand with a point count of less than 17 in required order of priority of 11, 10, 9, 8 and 7.

11. The method of claim 6 wherein the dealer position discards one card from the player position three playing cards to form an initial player position two-card blackjack hand to form a hand with a point count of less than 17 in required order of priority of 11, 10, 9, 8 and 7.

12. A method for conducting an electronic blackjack-style card game using:
a) a processor accepting an ante wager on a round of blackjack at a player position from a player input terminal;
b) the processor sending virtual images of three virtual random playing cards to a display system at the player position;
c) the processor sending virtual images of three virtual random playing cards to a display system at a dealer position;
d) the player position receiving signals at the player input terminal directing discard of a specific one of the three virtual playing cards at the player position to form an initial two-card player position blackjack hand;
e) the player position completing a final player position blackjack hand by receipt of signals through the player input terminal of commands to the processor to hit or stand at the player position;
f) after completion of a final player position blackjack hand, the dealer position two-card initial virtual playing card hand is completed by exercise of commands by the processor according to procedures stored in memory; and
g) the processor resolving the ante wager according to blackjack comparison between a virtual player hand outcome and a virtual dealer hand outcome.

13. The method of claim 12 wherein specific physical controls selected from the group selected from an area on a touchscreen and buttons are manipulated to direct a hit or a stand at the dealer position.

14. The method of claim 13 wherein the specific controls also comprise an area on a touchscreen and buttons are manipulated to suggest a strategy to the player position as to whether to hit, stand or double-down on at least a two-card hand.

15. The method of claim 12 wherein the player position discards one card from the player position three playing cards to form an initial player position two-card blackjack hand to form the highest two-card point total of 17, 18, 19, 20 or 21.

16. The method of claim 12 wherein the dealer position discards one card from the player position three playing cards to form an initial player position two-card blackjack hand to form a hand with a point count of less than 17 in required order of priority of 11, 10, 9, 8, 7, 6, 5, 4, 3, 2, 12, 13, 14, 15 and 16.

17. The method of claim 12 wherein the dealer position discards one card from the player position three playing cards to form an initial player position two-card blackjack hand to form a hand with a point count of less than 17 in required order of priority of 11, 10, 9, 8 and 7.

18. The method of claim 15 wherein the dealer position discards one card from the player position three playing cards to form an initial player position two-card blackjack hand to form a hand with a point count of less than 17 in required order of priority of 11, 10, 9, 8 and 7.
